(19) United States
(12) Patent Application Publication
(10) Pub. No.: US 2008/0149754 A1
(43) Pub. Date: Jun. 26, 2008

(54) Netting Dispenser-Collector with Automatic Tension Control

(76) Inventor: Andrew J. Flocchini, Petaluma, CA (US)

Correspondence Address: EDWARD S. SHERMAN, ESQ., 3554 ROUND BARN BLVD., SUITE 303, SANTA ROSA, CA, 95403, US

(21) Appl. No.: 11/614,214

(22) Filed: Dec. 21, 2006

(51) Int. Cl. A01G 13/02; B65H 75/40

(52) U.S. Cl. 242/403; 47/32.2

(57) ABSTRACT

A netting deployment and recovery system for covering vines and row crops has a collecting and dispensing cart that travels aside the row to be covered while netting is unrolled from a spool and guided overhead to a sweep tube mounted on a boom. In deploying the netting, a sweep tube directs the netting from the spool up over the row such that it spreads outward and lays over the row as the cart moves forward. In removing the netting the sweep tube gathers the relatively open netting at the upper end and conveys it in a compressed form back to the take up reels. The sweep tube is mounted to pivot about the boom in response to excess tension when the netting is deployed or removed. Such pivoting of the sweep tube engages an actuator to modulate the rotation of the take up reel. The orientation of the sweep tube is reversed for deployment and retrieval of the netting. In retrieving the netting the tension of the netting is reduced via the take up spool to avoid breakage. In deploying the netting, take up wheel rotates under a controlled range of tension. The pivot of the sweep tube is preferably resisted by an adjustable spring.

### CROSS REFERENCE TO RELATED APPLICATIONS

None

### BACKGROUND OF INVENTION

The present invention relates to an improved apparatus and method for dispensing and retrieving crop covering materials.

Prior methods of dispensing and retrieving crop covering materials, in particular netting intended to protect crops such as grapes from birds, are disclosed in U.S. Pat. No. 5,956,923, which is incorporated herein by reference.

While the apparatus described in the above patent offers significant improvements over prior methods, it requires significant care and diligence to prevent the netting from breaking, if for example if it is snagged during retrieval. Alternatively, during dispensing of the netting, it can be difficult to dispense the netting under a moderate tension that facilitates its manual spreading out over the crop as it is dispensed. The tension is to high, the netting can break. If it is too slack it tends to bunch up as it dispenses, requiring greater care to spread it out over the crop without tangles. Further, as such netting.

In principle it wound appear that the tension during dispensing can be controlled by the rate at which the tractor or other vehicle towing or moving reels that hold and then unwind the netting advance in proportion to the unwind rate, this is not the case, as the linear rate of dispensing decreases as the diameter of the wrapped netting decreases as the take up reel empties. As such bird protective netting is expensive and delicate; it requires extra operators to avoid breakage or snagging of the netting.

It is therefore a first object of the present invention to provide an improved means of dispensing crop protective material, such as bird netting at a controlled tension.

It is a further objective to provide an automated means of tension control independent of the speed of the vehicle moving the netting reels

It is a further objective to provide an improved means to retrieve netting that avoids breakage.

It is still another object of the invention to provide an improved means to automatically retrieve the netting without breakage relatively independent of the speeds of the vehicle housing the take up reels.

### SUMMARY OF INVENTION

In the present invention, the first and other object of the invention are achieved by providing a dispensing an retrieval mechanism that comprises a take up mechanism for crop netting, the mechanism comprising: a laterally extending boom, an arcuate sweep tube for collecting open netting at a first end and dispensing compressed netting at the second and opposite end, a rotary pivot coupling said arcuate sweep tube proximate said second end to said laterally extending boom, a spring coupled to at least one of said arcuate sweep tube and laterally extending boom for resisting the rotation of said laterally extending boom about said rotary pivot, an actuator coupled to at least one of said arcuate sweep tube and laterally extending boom for modify the take up or release rate of the compressed netting collected by said arcuate sweep tube in response to a variation in tension of the netting that causes the movement of said rotary pivot.

A second aspect of the invention is characterized in that the boom optionally includes a rotary coupling for inverting the orientation of the sweep tube between a position for dispensing or taking up the netting.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a plan view of the operative portion of the device deploying netting.

FIG. 2 is a plan view of the operative portion of the device retrieving netting.

FIG. 3 is a rear elevation of the operative portion of the device that includes a preferred embodiment of the boom.

FIG. 4 a rear elevation of an alternative embodiment of the device.

FIG. 5 is a rear elevation of the device that shows the entire cart.

### DETAILED DESCRIPTION

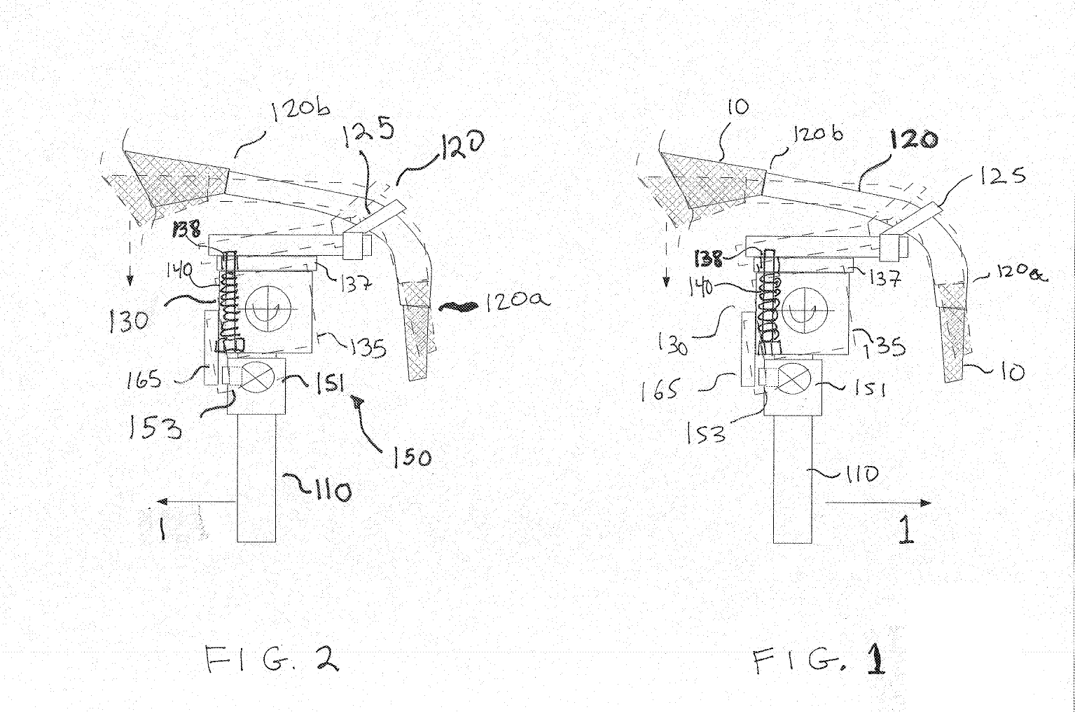

Referring to FIGS. 1 through 5, wherein like reference numerals refer to like components in the various views, there is illustrated therein a new and improved netting dispenser-collector with automatic tension control, generally denominated 100 herein.

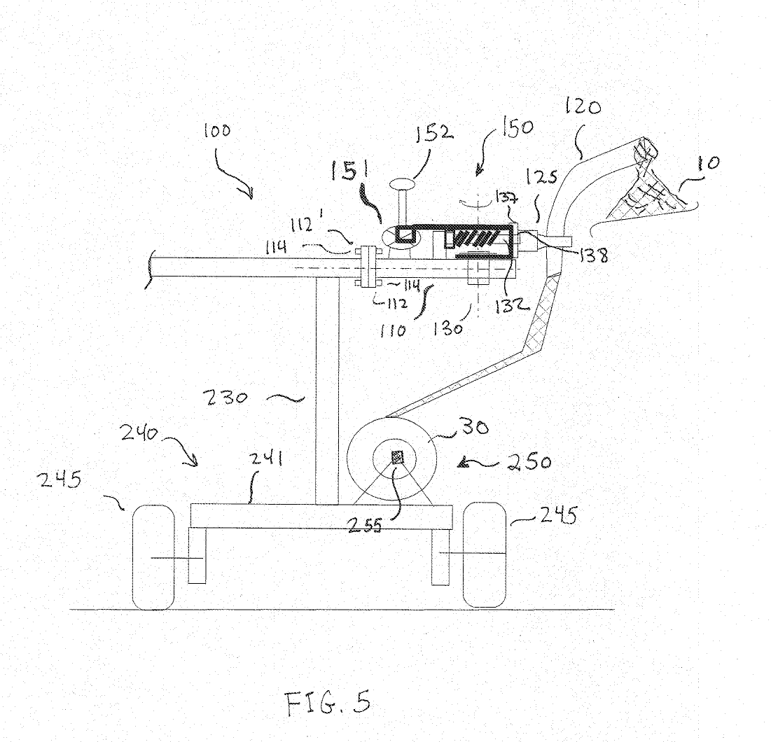

In accordance with the present invention, FIG. 5 is a rear elevation view of the netting dispenser-collector with automatic tension control 100.

The netting dispenser 100 includes take up reels for holding and then dispensing or retrieving the netting 10 through an arcuate sweep tube 120. The protective netting 10 is generally wrapped in a continuous coil around spindle 30 for storage. Thus the take up reel 250 and the associated rotary drive mechanism support and rotate the spindles to either dispense or recover the netting 10.

The sweep tube 120 is mounted on a laterally extending boom 110 mounted on top of a vertical supporting pole 230. The vertical supporting pole 230 extends upward from the base of cart 240. The cart 240 has either wheel 245 or other ground support structure, such as rails, as it is intended to be pulled by a tractor. However, it is also optional that the cart includes a means to turn the wheels/treads such that it is an independently powered vehicle. The take up reels 250 are also mounted on the base 241 of cart 240, and includes a drive mechanism 255 as well be further described with respect to different embodiment of the actuator 150 that provides automatic tension control. The actuator 150 includes a pivot coupling 130, such as a swivel or rotary connector, between the boom 110 and the sweep tube 120, generally through the mounting fixture 125 that holds the sweep tube 120.

FIG. 1 shows a presently preferred embodiment of the actuator 150. The sweep tube 120 and mounting fixture 125 are shown an alternative position in broken or dashed lines when the actuator 150 is engaged or trigger. The operative principle of the improved netting dispenser-collector is that when the tension on the netting exceed a predetermined level the sweep tube 120 will move, flex or rotate to an alternative position, such as (but not limited to) that shown in FIGS. 1 and 2, wherein either the movement, or the sensing of the predetermined force on the sweep tube 120 modulates the drive mechanism 255 of take up reel 250 so as to lower the tension on the netting. Generally, the form of modulation is to release the take up reel 250 from the drive mechanism 255 so that it spins freely.

In a preferred embodiment, the actuator 150 includes a hydraulic fluid control valve 151, with a lever 152. Hydraulic pump drives are commonly used in agriculture equipment as they can be coupled to a hydraulic system of a tractor that uses the rotary motion of the engine to drive a rotary pump. The hydraulic fluid control valve 152 interrupts the flow of hydraulic fluid to a hydraulically operated drive mechanism 255 so that the take up reels 250 can spin freely, releasing tension on the netting 10. The lever 152 is for manual opening of the valve 151. In additional to this optional lever 152 actuator for hand operation, the valve also has a release valve button 153 that is either electronically or mechanically depressed to perform the functional equivalent of operating the lever 152, to allow the take up reels 250 to spin freely.

It should be appreciated that in alternative embodiments of the invention the actuator 150 can electrically or mechanically decouple the rotary power used to turn the take up reels so that the reels either spin freely, or at a modified speed to decrease or increase the tension on the netting as appropriate.

Referring back to FIGS. 1 and 2, the pivot mechanism 130 is illustrated as being mounted on the boom 110. The sweep tube 120 generally includes a support and mounting structure 125 that rotates with respect to the pivot mechanism 130. Arrow 1 in each of FIGS. 1 and 2 shows the direction of motion of the vehicle/cart assembly 240 that holds boom 110 above the vine or crop row.

The portion of the pivot mechanism 130 in FIGS. 1 and 2 mounted to the boom includes a shaft 132 extending outward in the direction of the boom toward sweep tube. A coiled spring 140 surrounds the shaft 132.

Preferably the shaft 132 is threaded to receive a nut 133 that can be rotated and thus moved laterally to pre-compress the spring 140. The pre-compression of the spring 140 increases its relative stiffness and thus the force required to rotate the pivot mechanism 130 and hence is one of many alternative means for varying the preset the tension control level of the apparatus 100. It should be appreciated that when actuator 150 is an electronic device, the tension control is programmable rather than set by a physical adjustment of a component, such as nut 133.

The pivoting portion 135 of actuator 150 is disposed orthogonal to the rotation axis 20 of pivot mechanism 130. This pivoting portion 135 has a top plate 136 and a side plate 137. The sweep tube mount 121 can be connected to any portion of this pivoting portion 135. The side plate 137 has a hole or bore 138 disposed to allow the end of the shaft 132 to extend there through. As this hole or bore 138 is larger than the diameter of the shaft but smaller than the diameter of the spring 140, the spring 140 is retained on the shaft 132 but disposed to now resist the rotation of the pivoting portion 135 as such rotation urges the side plate 137 against the end of spring adjacent hole 138. When the tension on the netting 10 reaches a level sufficient to urge the sweep tube 120 to overcome the spring 140 and hence rotate the pivoting portion 135, an protrusion 165 extending down from the side of top plate 136 opposite side plate 137 will then depresses the release valve button 153. Thus, valve 151 then opens to divert the hydraulic fluid from drive 255 so that take up reels 255 can spin freely.

In the dispensing operation of FIG. 1, the netting 10 is fed from the take up reels 250 to entry sides 120a of the sweep tube 120, which then directs it upward and laterally to be unraveled at the opposite end 120b over the vine or crop row. The adjustable setting of the pole and the boom allow the position of the exit or outboard side 120b of the sweep tube 120 above the vines or crops to be protected. During dispensing one end of the netting 10 is anchored to a post or stake at the end of the row. Thus as the cart 240 is driven down the row the take up reel 250 unwinds the coil of netting so that is dispended along the row crop. Generally, depending on the crop dimensions, the netting 10 is then manually spread out as it exits the sweep tube 120 by assistants on opposite side of the crop row. Alternatively, as taught in the '923 patent additional hardware and equipment may be used to spread the netting laterally.

During dispensing it is desirable to uncoil the netting 10 at the same linear rate, which is linear feet in length of dispensed netting per unit time, at the same speed as the cart 240 move forward. Theoretically, this can be accomplished without a change is stress on the netting 10 as long as these speeds are evenly matched. While it is also possible to allow the stress in the netting to freely spin the take up reels 250 this is generally not desired, as it leads to the uneven dispensing of netting. Thus, it is more preferable to drive the take up reel 250 at the same speed as the cart 240 with a slight tension on the netting so that is can be more readily spread over the crops. Thus, in the preferred mode of operation on dispensing the netting 10, should the stress exceed the predetermined and desired value, typically no more than about half the tensile strength of the netting, the actuator 150 is intended to release the take up reel 250 from the drive 255 so that is can spin freely.

Further, it is desired that once this stress is released, rather than having the take up reel 250 continue to speed freely it is preferred that the rotary drive again be engaged. Thus, having spring 140 disposed to opposes the rotation of sweep tube 120 accomplishes this objective, as it continuously urges the sweep tube to move outward so at to release actuator 150.

In removal of the netting, as shown in FIG. 2, the netting is first manually removed from the end of the crop or vine row and fed into the outer end 120b of the sweep tube 120 so that is can be directed from the opposite end 120a to the take up reels. In taking up the netting 10 the take up reel 250 must be driven so the netting compresses into the sweep tube. However, should the netting 10 snag, the actuator 150 acts to disengage the take up reel drive 255 until the stress is reduced to the present level.

FIG. 1 illustrates the configuration of the sweep tube 120 when netting 10 is being released to cover rows crops or vines. Usually the take up reel 250 is allowed to freely rotate, independent of the vehicle/cart speed such that netting 10 is feed out through the sweep tube by the tension exerted by moving the cart. However, it is more desirable to apply the netting 10 with a controlled tension on the roller such that the netting is easier to spread over the crops and does not bunch up on itself after it is dispended. In this case, it is desirable to have the spindle rotate at speed that belays the netting at the same rate as the linear motion of the vehicle. However, it is not sufficient that the netting spindle merely unwind in proportion to the speed of the vehicle, as the length of netting deployed in each turn of the spindle varies with the thickness of netting build up on the spindle. That is, as the spindle 30 starts to unwind and is full of netting each turn deploys a length of netting 10 equal to the current circumference of the netting 10 on the spindle 30. However, as the netting 10 is depleted from the cylinder, the circumference decreases such that less netting 10 is deployed per turn. Thus, if the tractor or other device moving the cart 240 does not decrease in speed, the tension will increase in the netting unless it can be deployed faster. Thus, using the above tension control mechanism to vary the take up reel 250 rotation speed between a fixed rate, when the tension setting is not exceeded, and the free wheeling mode when it is, prevents the breakage of netting as well as accommodates a range of vehicle speeds making the process easier to control.

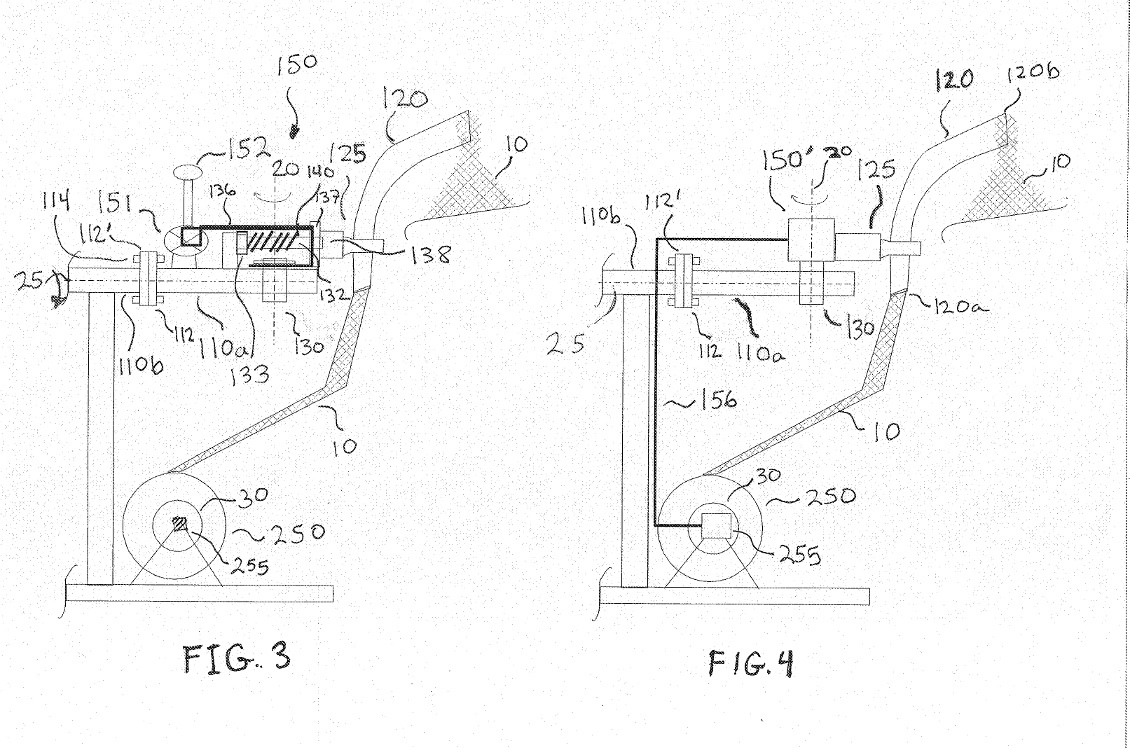

FIG. 3 shows a preferred embodiment of a means to adjust the position of the sweep tube 120 between the dispending and take up positions shown in FIG. 1 and FIG. 2

Preferably the boom 110 is subdivided into an outer portion 110a that supports the pivot mechanism 130 and inner portion 110b that is vertical supported by upright pole 230. The inner and outer portions 110a and 110b of the boom are attached by a pair of mating flanges 112 and 112′ via bolts 114. A rotary axle preferable extends through the inner and outer portion of the boom, being disposed along the horizontal rotation axis 25. Thus, when bolts 114 are removed the outer portion of the boom 110a can be rotated 180 degrees about rotation axis 25 inverting the pivot actuator 150 and thus flopping the sweep tube entrance 110a and exit 10b positions between the front and back of the cart 240. Preferably the flanges 112 and 112 have symmetrical pattern of bolt holes with respect to the horizontal center of the boom so that the same holes can be used when the sweep tube position is flopped.

Flopping the orientation of the sweep tube 120 between take up and deployment is of course only necessary when the cart can only move in one direction, such as when a single tractor hitch is attached to one end. A self powered cart or a cart with a hitch at both ends can be used for deployment and retrieval of netting without flopping the orientation of the sweep tube.

FIG. 4 shows an alternative embodiment using an electronic actuator 150′ to control take up roll 250. Actuator 150′ electronically determines either the rotation about pivot 130 or the torque about axis 20 using any suitable type of stress, strain or pressure gauge. Then, when the predetermined pivoting movement or torque is reached, the actuator 150′ through signal cable 156 reduces the tension on the netting, for example as shown electronically disconnecting the take up reel 250 and spindle from the drive mechanism 255. Alternatively, the actuator 150′ can also modulate or speed up the drive mechanism, or the velocity of the cart, to reduce the tension on the cable at a lower level of stress by other means before the take up reel 250 would be disengaged to spin freely, as this would result in the more even dispensing or recovering of the netting 10.

It should be appreciated that many alternative arrangements to the pivot mechanism 130 shown in FIGS. 1 and 2 are possible, thus to the extent that a spring is used to resist the rotary motion of a component having a mechanical actuator, the spring is optionally a torsion spring around the rotary pivot or compression spring mounted transverse to the pivot axis. It should also be appreciated that depending on the location of the take up reels 250 the sweep tube 120 may differ in shape and orientation, either requiring or allowing an alternative disposition of the pivot axis 20.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A take up mechanism for crop netting, the mechanism comprising:
a) a laterally extending boom
b) an arcuate sweep tube for collecting open netting at a first end and dispensing compressed netting at the second and opposite end,
c) a rotary pivot coupling said arcuate sweep tube proximate said second end to said laterally extending boom,
d) a spring coupled to at least one of said arcuate sweep tube and laterally extending boom for resisting the rotation of said laterally extending boom about said rotary pivot,
e) an actuator coupled to at least one of said arcuate sweep tube and laterally extending boom for modify the take up rate of the compressed netting collected by said arcuate sweep tube in response to a variation in tension of the netting that causes the movement of said rotary pivot.

2. A take up mechanism for crop netting according to claim 1 wherein further comprising means to adjust the tension on the spring to modify the stress required to trigger said actuator.

3. A take up mechanism for crop netting according to claim 2 wherein said means to adjust the spring tension is the pre-compression of said spring.

4. A take up mechanism for crop netting according to claim 1 wherein said spring is a compression spring.

5. A take up mechanism for crop netting according to claim 2 wherein the spring is a compression spring disposed about a shaft, the shaft being threaded to further comprises a nut that acts presses against said spring as a means to adjust the spring tension.

6. A take up mechanism for crop netting according to claim 1 wherein the spring is a torsion spring.

7. A take up mechanism for crop netting, the mechanism comprising:
a) a laterally extending boom,
b) an arcuate sweep tube for collecting open netting at a first end and dispensing compressed netting at the second and opposite end,
c) a rotary pivot coupling said arcuate sweep tube proximate said second end to said laterally extending boom,
d) an actuator coupled to at least one of said arcuate sweep tube and laterally extending boom and having means to modify the take up rate of the compressed netting collected by said arcuate sweep tube in response to a variation in tension of the netting as exerted on said sweep tube.

8. A take up mechanism for crop netting according to claim 7 wherein said means to modify the take up rate of the compressed netting collected by said arcuate sweep tube are mechanical.

9. A take up mechanism for crop netting according to claim 7 wherein said means to modify the take up rate of the compressed netting collected by said arcuate sweep tube are electrical.

10. A take up mechanism for crop netting according to claim 7 wherein the modification of the take up rate is a release of the drive mechanism that allow the take up real to spin freely

11. A take up mechanism for crop netting according to claim 7 wherein the modification of the take up rate is a reduction in the take up rate.

12. A dispensing cart for collecting and deploying crop netting, said dispensing cart comprising,
a) a cart having a ground support mechanism,
b) a rotary take up reel mounted on said cart,
c) a post having a first and lower end coupled to said cart and extending vertically upward such that the second end of said post is above the first end,
d) a boom laterally extended and coupled proximate to second end of said post,
e) an arcuate sweep tube for collecting open netting at a first end and dispensing compressed netting at the second and opposite end to be conveyed to said rotary take up reel,
f) wherein the sweep tube is mounted to the boom via an actuator capable of modulating the rotary movement of the take up reel in response to a variation in the tension transmitted by netting that extends outward from the seep tube as it is that is wound or unwound from the take up reel.

13. A dispensing cart for collecting and deploying crop netting according to claim 12 wherein the actuator is a mechanical actuator.

14. A dispensing cart for collecting and deploying crop netting according to claim 12 wherein the actuator is an electrical actuator.

15. A dispensing cart for collecting and deploying crop netting according to claim 12 wherein the ground support mechanism, at least two wheel for rolling or propulsion along the ground.

16. A dispensing cart for collecting and deploying crop netting according to claim 12 wherein the ground support mechanism is selected from the group consisting of wheels, treads and rails.

17. A dispensing cart for collecting and deploying crop netting according to claim 12 wherein said laterally extended boom is comprised of an inner portion fixed to said post relative to an outer portion supporting said actuator, the outer portion being rotatable by 180 degrees with respect to said inner portion so as to inert the position of the sweep tube with respect to the front and back of the cart.

18. A dispensing cart for collecting and deploying crop netting according to claim 17 wherein the inner and outer portion of said laterally extending boom are connected by a flange.

19. A dispensing cart for collecting and deploying crop netting according to claim 18 wherein the flanges are held together by bolts extending through holes that are symmetrical with respect to the horizontal center of the boom.
